(19) United States
(12) Patent Application Publication
(10) Pub. No.: US 2010/0104697 A1
(43) Pub. Date: Apr. 29, 2010

(54) Bottles with Controlled Bubble Release

(75) Inventors: Robert Kriegel, Decatur, GA (US); Xiaoyan Huang, Marietta, GA (US); Robert P. Grant, Alpharetta, GA (US); Harish Radhakrishna, Tucker, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 12/604,599

(22) Filed: Oct. 23, 2009

Related U.S. Application Data
(60) Provisional application No. 61/107,704, filed on Oct. 23, 2008.

(51) Int. Cl. B65D 85/73; B65B 3/00; B44C 1/22

(52) U.S. Cl. 426/87; 426/106; 426/397; 426/383; 216/28

(57) ABSTRACT

A container with a carbonated fluid therein. The container may include a base and a sidewall positioned about the base. The base and/or the sidewall may include a number of nucleation sites thereon. The nucleation sites may be positioned to form a number of bubbles in a pattern when the container is opened

### TECHNICAL FIELD

The present application relates generally to bottles and other types of containers for carbonated beverages and more particularly relates to bottles and other types of containers with controlled bubble release therein, methods of manufacture, and methods of use.

### BACKGROUND OF THE INVENTION

Many types of carbonated beverages are known. These beverages contain dissolved carbon dioxide and other gases as a result of fermentation (e.g., beer, sparkling wines, etc.) or by the addition of the gases (e.g., carbonated soft drinks and the like). Through the process of effervescence, these beverages discharge the dissolved gases in part via bubbling. The nature of the bubbles and the bubbling process may have an impact on flavor release, mouth feel, visual effect, and other characteristics of the drinking experience for the consumer.

In the case of a carbonated soft drink and the like, varying levels of carbonation may be used. Generally described, the beverage is poured into a container such as a bottle or a can and the container is sealed for delivery to the consumer. The liquid and the gas of the beverage remain largely at equilibrium while the container is sealed. Specifically, the partial pressure of a given gas above a solution is proportional to the concentration of the gas dissolved in the solution. When the container is opened, however, the partial pressure of the gas in the head space falls. The equilibrium of the beverage within the container thus ends and the dissolved gas in the liquid quickly seeks to escape. The result is the formation of the bubbles within the liquid as the gas escapes. The bubbles generally form at nucleation sites along the base or the walls within the container. To date, the bubbles are produced and released in a largely random and uncontrolled manner.

At least with respect to carbonated soft drinks and the like, the impact of the bubbles and their release on a consumer's visual perception of the beverage and even on the consumer's taste experience of the beverage has not been explored in detail. There is thus a desire for bottles and other types of containers with improved bubble release mechanisms and controls. Such mechanisms and controls preferably can provide an improved consumer experience, an improved consumer recognition of the beverage, and an improved beverage taste without significant additional costs or other types of drawbacks.

### SUMMARY OF THE INVENTION

The present application thus describes a container with a carbonated fluid therein. The container may include a base and a sidewall positioned about the base. The base and/or the sidewall may include a number of nucleation sites thereon. The nucleation sites may be positioned to form a number of bubbles in a pattern when the container is opened.

The container may include a bottle and may be made out of glass or plastic. The container may include a cap. The pattern may be a logo or an identification of source. The nucleation sites may include a number of rough spots, a number of areas of differing surface energy, or a number of etchings positioned about the base and/or the sidewall. The nucleation sites may include a number of shapes and may create a number of bubble shapes.

The application further describes a method of controlling the release of bubbles in a carbonated beverage in a container. The method may include the steps of applying a number of nucleation sites to an interior of the container, positioning the nucleation sites in a pattern, filling the container with the carbonated beverage, enclosing the container, opening the container, and forming bubbles according to the pattern of the nucleation sites.

The step of positioning the nucleation sites in a pattern may include positioning the number of nucleation sites in a logo or an identification of source. The step of applying the nucleation sites to an interior of the container may include applying a number of rough spots, a number of areas of differing surface energy, or a number of etchings.

The application further describes a bottle with a carbonated soft drink therein. The bottle may include a base, a sidewall positioned about the base, and a cap enclosing the bottle. The base and/or the sidewall may include a number of nucleation sites thereon. The nucleation sites may be positioned to form a number of bubbles in a pattern in the carbonated soft drink when the bottle is opened. The pattern may include an identification of source.

These and other improved features of the present application will become apparent to one of ordinary skill in the art upon review of the following detailed description when taken in conjunction with the several drawings and the appended claims.

### BRIEF DESCRIPTION OF THE DRAWINGS

FIG. 1 is a side cross-sectional view of a container as may be used herein.

FIG. 2 is a top plan view of a container base with the nucleation sites described herein.

FIG. 3 is a perspective view of the container base of FIG. 2.

FIG. 4 is a top plan view of an alternative embodiment of a container base as may be described herein.

FIG. 5 is a top plan view of an alternative embodiment of a container base as may be described herein.

FIG. 6A is a cross-sectional view of a preform that may be used herein.

FIG. 6B is a further cross-sectional view of the preform of FIG. 6A.

FIG. 7A is a cross-sectional view of an alternative preform that may be used herein.

FIG. 7B is a further cross-sectional view of the preform of FIG. 7A.

FIG. 8A is a cross-sectional view of an alternative preform that may be used herein.

FIG. 8B is a further cross-sectional view of the preform of FIG. 8A.

### DETAILED DESCRIPTION

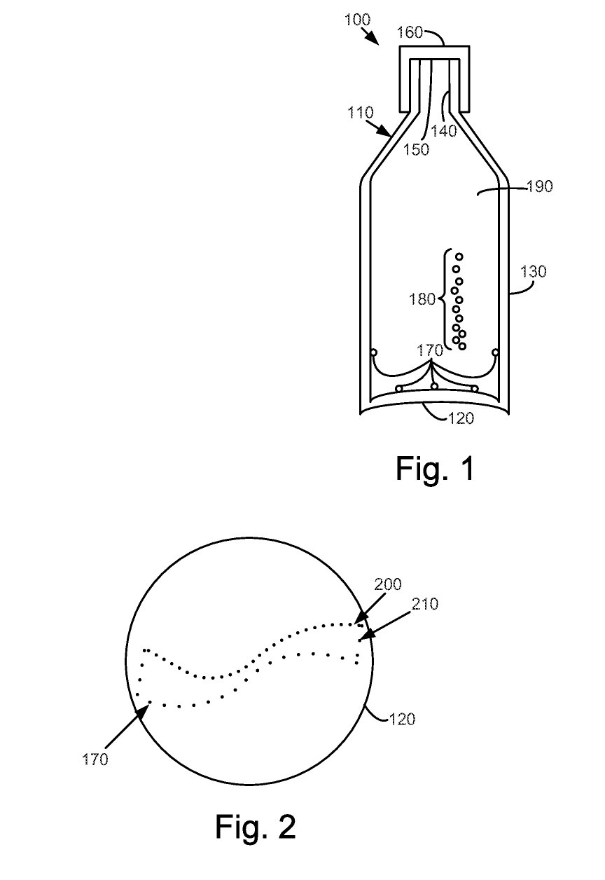

Referring now to the drawings, in which like numbers refer to like elements throughout the several views, FIG. 1 shows a container 100 as may be described herein. In this example, the container 100 may be a bottle 110. The container 100 also may be a can or any other type of receptacle. The bottle 110 may be made out of glass, plastics (poly(ethylene terephthalate) and the like), metals, or other types of materials. The material of the bottle 110 preferably is substantially transparent in whole or in part. The bottle 110 may take any convenient size or shape. The bottle 110 may include a base 120, a sidewall 130, a neck 140, and an opening 150. The opening 150 may be enclosed by a cap 160 or other type of enclosure. Any other configuration of the container 100 and the bottle 110 may be used herein.

The interior of the bottle 110 or other container 100 may include a number of nucleation sites 170. The nucleation sites 170 serve to create bubbles 180 within a carbonated fluid 190 positioned within the bottle 110. Specifically, the nucleation sites 170 create bubbles 180 in the bottle 110 when the cap 160 is removed and the pressure from the carbonated fluid 190 is released. The nucleation sites 170 may be positioned about the base 120 and/or the sidewall 130 of the bottle 110. Any number of nucleation sites 170 may be used. The size, shape, and position of the nucleation sites 170 may vary. The nucleation sites 170 may be created in any number of ways as will be described below.

The nucleation sites 170 may be positioned within the bottle 110 such that the bubbles 180 create a pattern 200 or other type of controlled visual impression. As is shown in FIG. 2, the nucleation sites 170 may be positioned about the base 120 and/or the sidewall 130 of the bottle 110 so as to create the pattern 200. In this example, the pattern 200 may be a logo 210, a trademark, other type of source identification, any type of design, or combinations thereof. The bubbles 180 thus may form the pattern 200. Specifically, single isolated bubbles 180 or ensembles of bubbles 180 may be created to form the pattern 20.

The nucleation sites 170 may have varying sizes and shapes and hence promote the creation of bubbles 180 of differing sizes and shapes in specific types of carbonated fluids 190. A nucleation site 170 of one shape or size, for example a sharp edge, may produce one type of bubble 180 while a nucleation site 170 of a second shape or size, for example a dull edge, may produce another type of bubble 180. In the case of a non-random surface texture, the size, shape, height, spacing and sharpness of the texture may determine the bubble size. Further, a line of nucleation sites 170 may create a line of bubbles 180 and so forth. Likewise, the delivery rate of the bubbles 180 may vary based upon the nature of the nucleation site 170 and/or the nature of the carbonated fluid 190.

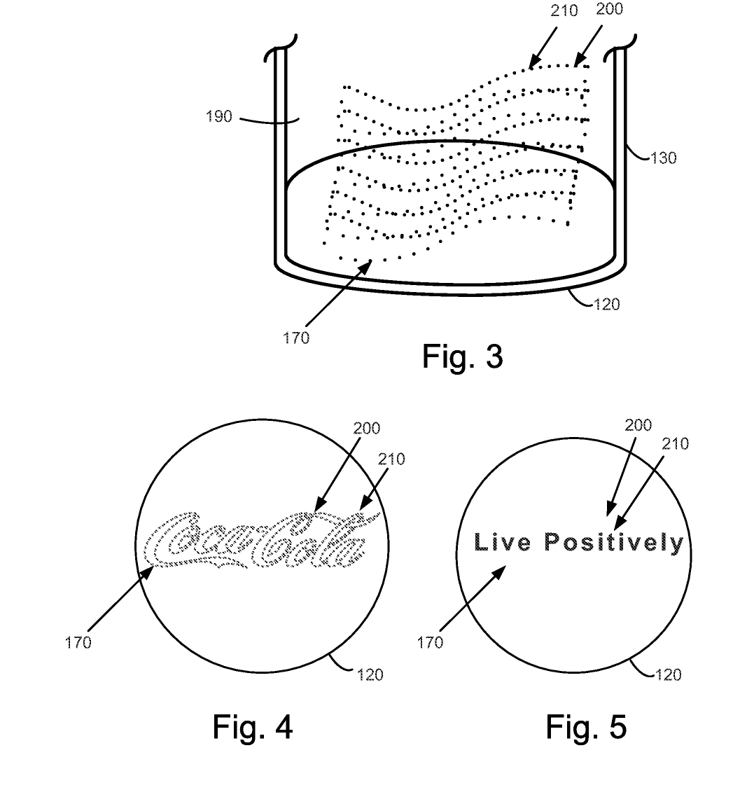

As referenced above, the pattern 200 of FIG. 2 shows a logo 210. In this example, the logo 210 may be the famous “Dynamic Ribbon” trademark of The Coca-Cola Company of Atlanta, Ga. As is shown in FIG. 3, the bubbles 180 remain largely in the pattern 200 as the bubbles 180 rise through the bottle 110. This pattern 200 is thus recognizable by the consumer.

The pattern of FIG. 4 shows the words “Coca-Cola”, also a trademark of The Coca-Cola Company of Atlanta, Ga. The pattern of FIG. 5 shows the words “Live Positively”. Any word or design may be used. The creation and use of the patterns 200 and the logos 210 when the bottle 110 is opened thus promotes branding and other consumer recognition of the beverage therein. Other types of patterns 200 may be used herein.

The nucleation sites 170 may be produced in any number of different ways. The nature of the material of the bottle 110 also may impact which technique may be appropriate for a given bottle. For example, the nucleation sites 170 may be a rough spot made through patterning or abrasion of the interior of the bottle 110. The abrasion techniques should work with any material.

The nucleation sites 170 may be incorporated into the base 120 or the sidewall 130 of the bottle 110 via a modified stretch rod used with an injection molding system. Such a stretch rod may have a textured surface at the end thereof such a knurled tip, a pointed tip, a triangular tip, or other shape. The textured surface also may contain the pattern 200 thereon so as to create the rough spots through abrasion or otherwise during the molding process. The rough spots may be convex, concave, other shapes, or combinations thereof. The pattern 200 may be molded therein without impacting the stability of the bottle 110 as a whole. The stretch rod may be used with plastic materials as is known.

The nucleation sites 170 also may be placed by using custom molded features put in place during the injection molding process. For example, a designed surface modification of a core pin can imprint a modified surface inside a preform. These features may be added at or near the gate area of the preform or otherwise.

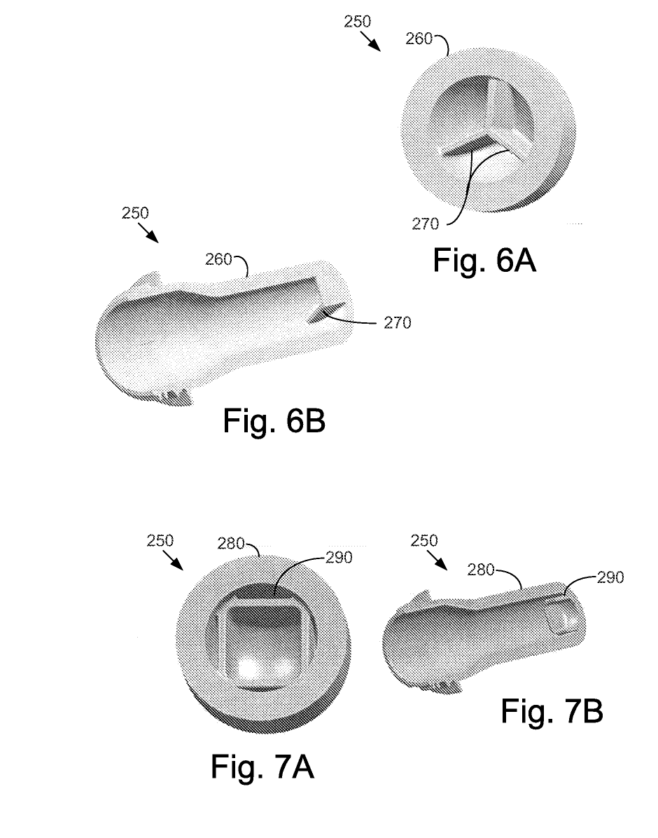

FIGS. 6-8 show various types of preforms 250 that may be used herein. For example, FIGS. 6A and 6B show a three spoke web preform 260. As is shown, the three spoke web preform 260 includes three spokes 270 meeting in the center of the preform 260 at one end thereof. During the blow molding process, the stretch rod will crush at least a portion of the spokes 270 so as to cause sharp points or other types of irregular surfaces that may function as the nucleation sites 170. The preform 260 may have any number of spokes 270 or other shapes therein.

FIGS. 7A and 7B show a box shaped web preform 280. The tip of this preform 280 includes a box like web structure 290. As above, the stretch rod may crush at least a portion of the box like web 290 during the blow molding process so as to create sharp points or other types of irregular surfaces that may function as the nucleation sites 170. The preform 280 may have other shapes therein.

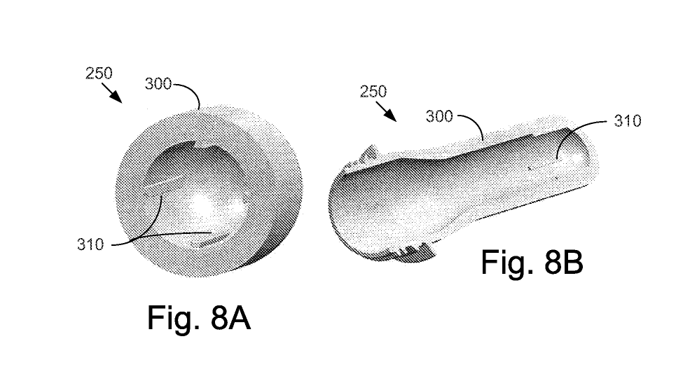

FIGS. 8A and 8B show a core rib preform 300. The core rib preform 300 includes a number of ribs 310 therein with a slight undercut. During the blow molding process, there should be at least some distortion in the ribs 310 so as to create the nucleation sites 170. The preform 300 may have any number of ribs 310 or other shapes therein. Other types of preform designs and features may be used herein to create the nucleation cites 170.

The nucleation sites 170 also may be areas of differing surface energy made by the application of other types of materials. Specifically, a flexible ink jet type printing method may be used to print hydrophobic or hydrophilic materials on the inside of the bottle 110 so as to provide differences in surface energy. Other types of materials may be used herein.

The nucleation sites 170 also may be created by via etching by laser or other methods. Laser etching and marking is common for printing the date and product codes on the outside of bottles. The use of multiple low power lasers focused such that the total power at the common focal point is much greater may allow for etching on the backside of the material. Using lasers or a high intensity light source, an internal coding may be applied to the bottle 110 and cured to promote adhesion. The use of a mask at the light source may provide the needed pattern forming capabilities.

Further, physical etching of the bottle 110 also may be performed by jetting ice or dry ice with appropriate patterning technology. Lasers and etching may be used with any type of material. Other types of physical etching techniques also may be used herein.

Other types of manufacturing techniques may be used herein to form the nucleation sites 170. Likewise, combinations of the different manufacturing techniques may be used herein so as to form varying types of nucleation sites 170. The varying types of nucleation sites 170 may produce varying types of bubbles 180 and different types of bubble release.

The use of the nucleation sites 170 thus serves to control the formation of the bubbles 180 when the container 100 or the bottle 110 is opened. The smaller the bubbles 180 may be upon reaching the surface, the greater the internal pressure and the energy release may be upon collapse. This greater energy release may be more efficient at volatizing aroma compounds so as to increase the olfactory sensation of the beverage. The impact of the size and the release of the bubbles 180 thus may be linked to aroma and to taste perception. The modification and modulation of the size and the density of the bubbles 180 thus may help to regulate flavor. Specifically, varying the size and the delivery rate of the bubbles 180 may impact taste, smell, mouth feel, and other perceptions of the consumer before and during the drinking experience.

The positioning of the nucleation sites 170 in turn provides the patterns 200 and logos 210 so as to provide a unique visible impression when the bottle 110 is opened so as to increase consumer recognition of the beverage therein. The nucleation sites 170 thus provide an improved consumer experience every time a bottle 110 is opened.

Formation of the bubbles 180 also may be promoted by the addition of surfactants to the carbonated fluid 190. The surfactants may be food grade sucrose esther F-110 or similar types of additives. Formation of the bubbles 180 at the nucleation sites 170 also may be aided by the bottle 110 being closed at least overnight or other extended period of time.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A container with a carbonated fluid therein, comprising:
a base;
a sidewall positioned about the base;
the base and/or the sidewall comprising a plurality of nucleation sites thereon; and
the plurality of nucleation sites positioned to form a plurality of bubbles in a pattern when the container is opened.

2. The container of claim 1, wherein the container comprises a bottle.

3. The container of claim 1, wherein the container comprises glass.

4. The container of claim 1, wherein the container comprises plastic.

5. The container of claim 1, further comprising a cap enclosing the container.

6. The container of claim 1, wherein the pattern comprises a logo.

7. The container of claim 1, wherein the pattern comprises an identification of source.

8. The container of claim 1, wherein the plurality of nucleation sites comprises a plurality of rough spots positioned about the base and/or the sidewall.

9. The container of claim 1, wherein the plurality of nucleation sites comprises a plurality of areas of differing surface energy positioned about the base and/or the sidewall.

10. The container of claim 1, wherein the plurality of nucleation sites comprises a plurality of etchings positioned about the base and/or the sidewall.

11. The container of claim 1, wherein the plurality of nucleation sites comprises a plurality of shapes.

12. The container of claim 11, wherein the plurality of nucleation sites creates a plurality of bubble shapes.

13. A method of controlling the release of bubbles in a carbonated beverage in a container, comprising:
applying a plurality of nucleation sites to an interior of the container;
positioning the plurality of nucleation sites in a pattern;
filling the container with the carbonated beverage;
enclosing the container;
opening the container; and
forming bubbles according to the pattern of the nucleation sites.

14. The method of claim 13, wherein positioning the plurality of nucleation sites in a pattern comprises positioning the plurality of nucleation sites in a logo.

15. The method of claim 13, wherein positioning the plurality of nucleation sites in a pattern comprises positioning the plurality of nucleation sites in an identification of source.

16. The method of claim 13, wherein applying a plurality of nucleation sites to an interior of the container comprises applying a plurality of rough spots.

17. The method of claim 13, wherein applying a plurality of nucleation sites to an interior of the container comprises applying a plurality of areas of differing surface energy.

18. The method of claim 13, wherein applying a plurality of nucleation sites to an interior of the container comprises applying a plurality of etchings.

19. A bottle with a carbonated soft drink therein, comprising:
a base;
a sidewall positioned about the base;
a cap enclosing the bottle;
the base and/or the sidewall comprising a plurality of nucleation sites thereon; and
the plurality of nucleation sites positioned to form a plurality of bubbles in a pattern in the carbonated soft drink when the bottle is opened.

20. The bottle of claim 19, wherein the pattern comprises an identification of source.
